(19) United States
(12) Patent Application Publication
(10) Pub. No.: US 2026/0240092 A1
(43) Pub. Date: Aug. 20, 2026

(54) GARDENING FLOW CONTROL TIMER

(71) Applicant: SHIN TAI SPURT WATER OF THE GARDEN TOOLS CO., LTD, Lukang Township (TW)

(72) Inventor: Chin-Yuan Chen, Lukang Township (TW)

(21) Appl. No.: 19/059,045

(22) Filed: Feb. 20, 2025

(51) Int. Cl. A01G 25/16; F16K 31/48

(52) U.S. Cl. CPC A01G 25/165; F16K 31/48

(57) ABSTRACT

A gardening flow control timer including a flow controller, a timer circuit, and an outer casing. The flow controller has an inlet portion, an outlet portion, and a valve body. The timer circuit has a substrate. The substrate contains a control program. The substrate has a start button and a single toggle switch connected to the start button. The substrate further has a timing unit. The timing unit has a rotating shaft extending therefrom and connecting to a turntable. The turntable has time markings equidistantly spaced such that each of the time markings denotes a unique countdown time. The outer casing is formed by aligning and combining a first casing body and a second casing body. The edges of the first casing body and the second casing body have notches. The first casing body has a through-hole and at least one perforation.

### FIELD

The present disclosure relates to a gardening flow control timer mounted on a gardening water supply system to control the timed opening and closing of water flow.

### BACKGROUND

A conventional gardening flow control valve has a water valve body and a timer. The water valve body has an inlet, an outlet, and an electromagnetic solenoid coil. The timer is disposed on a lateral side of the water valve body and adapted to supply electrical current to the electromagnetic solenoid coil. The timer has a display panel and a control interface. The control interface has a plurality of buttons, including an hour button, minute button, start button, stop button, and reset button. The timer has therein a processor and a battery. Since the buttons of the control interface can be pressed, with the display panel functioning, the timer can set the time at which the water valve body automatically opens and closes to achieve scheduled water supply.

However, in practice, the aforesaid conventional structures have drawbacks as follows: the buttons of the timer are structurally complicated and thus not intuitive enough; as a result, not every person (especially older seniors) is able to set the scheduled time of water supply, limiting the use of the conventional gardening flow control valve.

Therefore, a research and development goal for the related industry is to perform research and development and make improvements to overcome the drawbacks of the aforesaid conventional structures. In view of this, the inventor came up with an idea for an invention. To this end, the inventor undertook a design process based on years of experience, conducted extensive discussions, built prototypes to be tested, and made amendments and improvements, culminating in the realization of the invention.

### SUMMARY

The technical issue to address: The buttons of conventional timers are structurally complicated and thus not intuitive enough. This is the technical issue to address.

The technical features for addressing the technical issue: The disclosure provides a gardening flow control timer comprising a flow controller, a timer circuit, and an outer casing. The flow controller has an inlet portion and an outlet portion. A valve body is located between the inlet portion and the outlet portion and disposed on a lateral side of the flow controller. The valve body is electrically connected to the timer circuit in order to be controlled by the timer circuit to allow waterway inside the flow controller to open or close according to opening and closing variations resulting from the operation of the valve body. The timer circuit has a substrate. The substrate contains a control program. The substrate has a start button and a single toggle switch connected to the start button. The single toggle switch can be pressed to cause the start button to trigger the timer circuit and cause the substrate to record the time of the first trigger to not only allow the substrate to take the initiative to start the timer circuit at the same time every day thereafter, but also allow the single toggle switch to be pressed once again during the starting process of the timer circuit to perform the function of one-time shutdown. Furthermore, the substrate has a timing unit. The timing unit has a rotating shaft extending therefrom and connecting to a turntable. The turntable has a plurality of time markings equidistantly spaced such that each of the time markings denotes a unique countdown time. The outer casing is formed by aligning and combining a first casing body and a second casing body. The edges of the first casing body and the second casing body have a plurality of notches. The first casing body has a through-hole and at least one perforation. The first casing body and the second casing body are aligned and combined to allow the flow controller and the timer circuit to be further received in the outer casing; thus, not only can the inlet portion and the outlet portion protrude from the notches, but the through-hole also has a clearance function, allowing the turntable disposed outside the first casing body to connect with the timer circuit disposed in the outer casing, and allowing the single toggle switch to be exposed from the perforation. A pointer is disposed on the outer surface of the first casing body. A battery case that can be pulled outward is disposed in the second casing body. The battery case contains a battery for providing electric power to the timer circuit and the valve body in operation.

Advantages over the prior art:
(1) The disclosure provides gardening flow control timer is beneficial, not only because rotating the turntable and pressing the single toggle switch once together make setting the timer circuit intuitive and simple, but also because the structure that eliminates the need to press a lot of buttons but is still able to set water discharge time is easy to use.
(2) The disclosure provides gardening flow control timer is beneficial, not only because the timer circuit only needs to complete the initial rotation, and after pressing, it can achieve a normal water discharge at the same time every day, but also because the operation is so simple that the gardening flow control timer of the disclosure is suitable for all age groups.

### BRIEF DESCRIPTION OF THE DRAWING

FIG. 1 is a perspective view of the disclosure.

FIG. 2 is an exploded view of the disclosure.

FIG. 3 is a cross-sectional view of the disclosure.

FIG. 4 is a schematic view of how a turntable rotates according to the disclosure.

FIG. 5 is a schematic view of a single toggle switch pressed according to the disclosure.

FIG. 6 is a schematic view of allowing a water flow to pass as soon as the single toggle switch is pressed according to the disclosure.

FIG. 7 is a schematic view of allowing the water flow to pass at the same time on the same day thereafter according to the disclosure.

FIG. 8 is a schematic view of turning on an indicator light to prompt the user to replace a battery that is about to run out according to the disclosure.

### DETAILED DESCRIPTION

Objectives, features, and advantages of the disclosure are herein illustrated with specific embodiments, depicted with drawings, and described below.

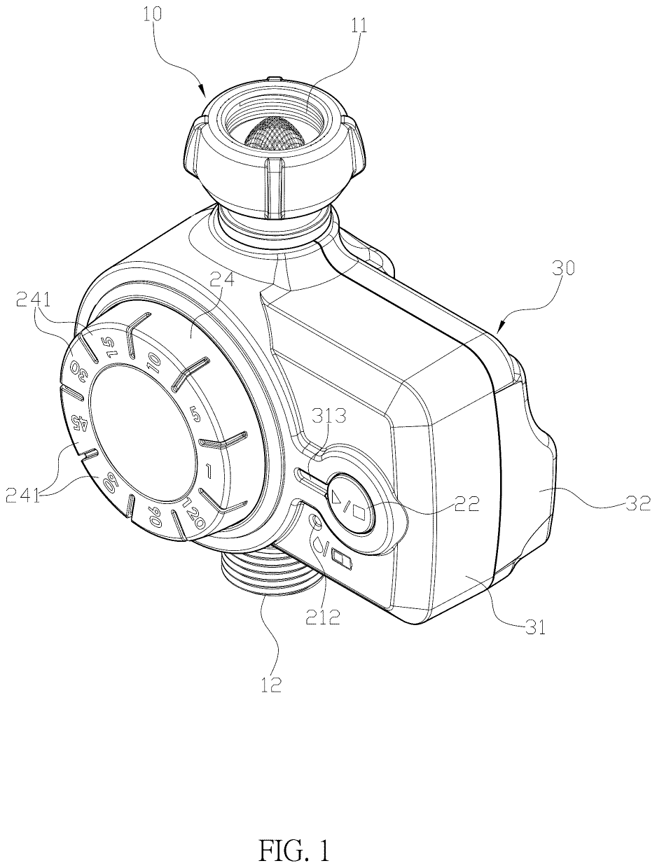

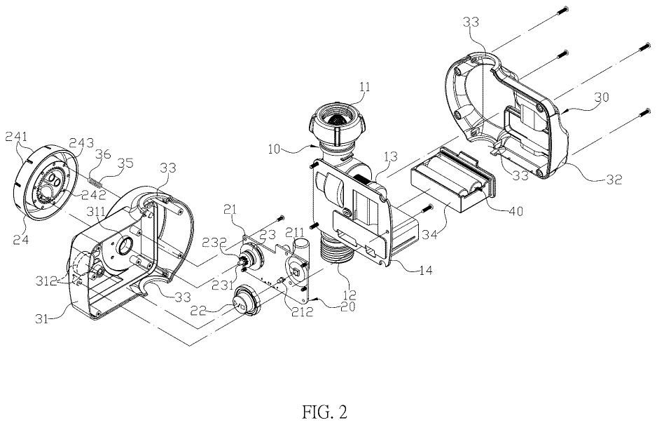

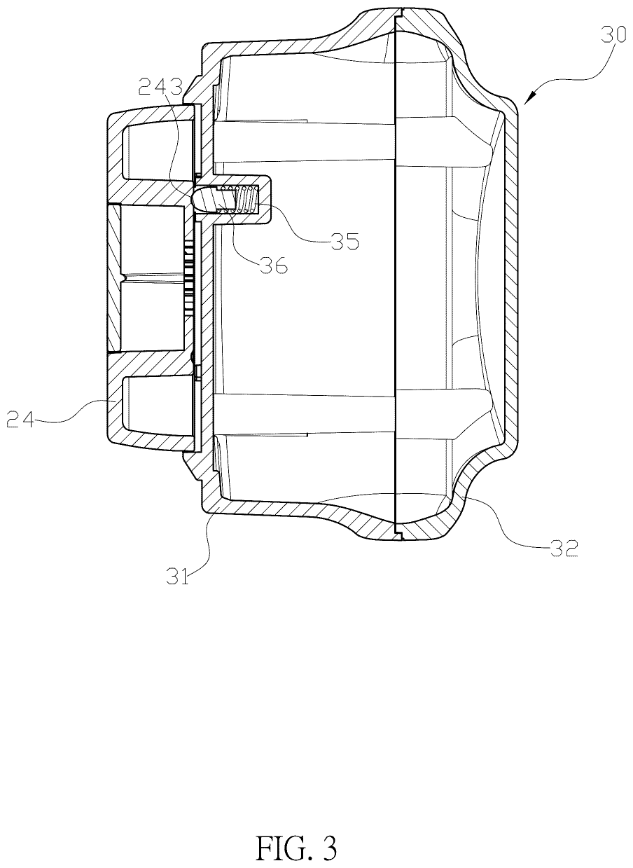

Referring to FIG. 1 through FIG. 3, a gardening flow control timer comprises a flow controller (10), a timer circuit (20), and an outer casing (30). The flow controller (10) has an inlet portion (11) and an outlet portion (12). A valve body (13) is located between the inlet portion (11) and the outlet portion (12) and disposed on a lateral side of the flow controller (10). The valve body (13) is electrically connected to the timer circuit (20) in order to be controlled by the timer circuit (20) to allow waterway inside the flow controller (10) to open or close according to opening and closing variations resulting from the operation of the valve body (13). The timer circuit (20) has a substrate (21). The substrate (21) contains a control program. The substrate (21) has a start button (211) and a single toggle switch (22) connected to the start button (211). The single toggle switch (22) can be pressed to cause the start button (211) to trigger the timer circuit (20) and cause the substrate (21) to record the time of the first trigger to not only allow the substrate (21) to take the initiative to start the timer circuit (20) at the same time every day thereafter, but also allow the single toggle switch (22) to be pressed once again during the starting process of the timer circuit (20) to perform the function of one-time shutdown. Furthermore, the substrate (21) has a timing unit (23). The timing unit (23) has a rotating shaft (231) extending therefrom and connecting to a turntable (24). The turntable (24) has a plurality of time markings (241) equidistantly spaced such that each of the time markings (241) denotes a unique countdown time. The outer casing (30) is formed by aligning and combining a first casing body (31) and a second casing body (32). The edges of the first casing body (31) and the second casing body (32) have a plurality of notches (33). The first casing body (31) has a through-hole (311) and at least one perforation (312). The first casing body (31) and the second casing body (32) are aligned and combined to allow the flow controller (10) and the timer circuit (20) to be further received in the outer casing (30); thus, not only can the inlet portion (11) and the outlet portion (12) protrude from the notches (33), but the through-hole (311) also has a clearance function, allowing the turntable (24) disposed outside the first casing body (31) to connect with the timer circuit (20) disposed in the outer casing (30), and allowing the single toggle switch (22) to be exposed from the perforation (312). A pointer (313) is disposed on the outer surface of the first casing body (31). A battery case (34) that can be pulled outward is disposed in the second casing body (32). The battery case (34) contains a battery (40) for providing electric power to the timer circuit (20) and the valve body (13) in operation.

The disclosure provides a gardening flow control timer, wherein the valve body (13) is an electromagnetic valve.

The disclosure provides a gardening flow control timer, wherein the flow controller (10) has a baffle (14) which the timer circuit (20) abuts against whenever the timer circuit (20) and the flow controller (10) are placed in the outer casing (30) and fastened in place.

The disclosure provides a gardening flow control timer, wherein the substrate (21) is a circuit board having a program chip.

The disclosure provides a gardening flow control timer, wherein the substrate (21) has thereon electronic components, such as a capacitor.

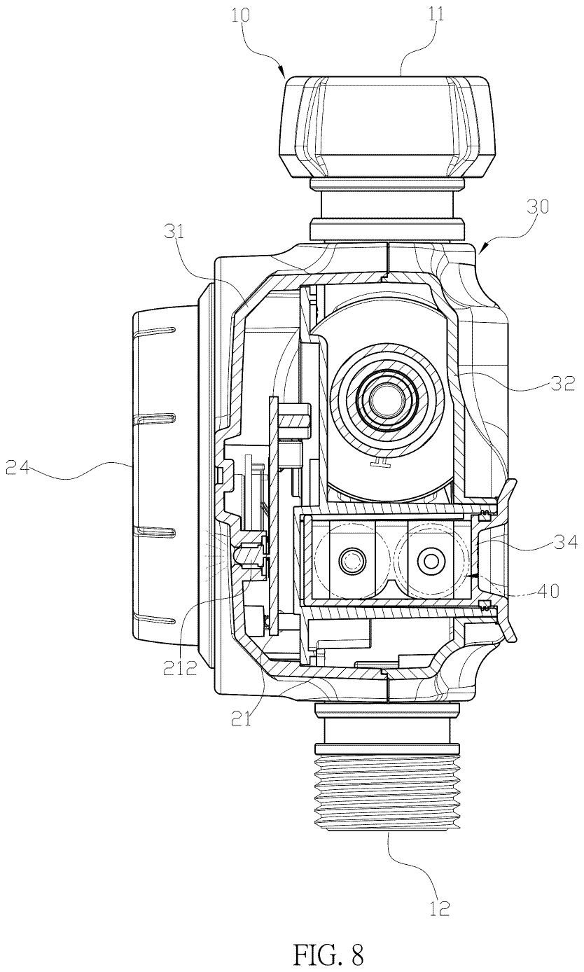

The disclosure provides a gardening flow control timer, wherein the substrate (21) has thereon an indicator light (212) that turns on to prompt the user to replace the battery (40) when the battery (40) is about to run out (as shown in FIG. 8). The indicator light (212) is exposed from the perforation (312). The program contained in the substrate (21) controllably causes the indicator light (212) to light up as soon as the timer circuit (20) starts and thereby allows a water flow to pass.

The disclosure provides a gardening flow control timer, wherein the rotating shaft (231) is connected to a gear (232), and the turntable (24) has an internal gear portion (242) meshing with the gear (232) to allow the turntable (24) and the rotating shaft (231) to transmit power more precisely.

The disclosure provides a gardening flow control timer, wherein the turntable (24) has the time markings (241) denoting one-minute, 5-minute, 10-minute, 15-minute, 30-minute, 45-minute, 60-minute, 90-minute, and 120-minute countdowns respectively.

The disclosure provides a gardening flow control timer, wherein each of the time markings (241) of the turntable (24) corresponds in position to a positioning hole (243), and the first casing body (31) has a positioning pin (36) capable of being pushed outward by a spring (35) and inserted into a corresponding one of the positioning holes (243) in the course of switching between the time markings (241) as a result of the rotation of the turntable (24) to not only achieve accurate positioning for switching but also generate a sharp gear-shifting feel.

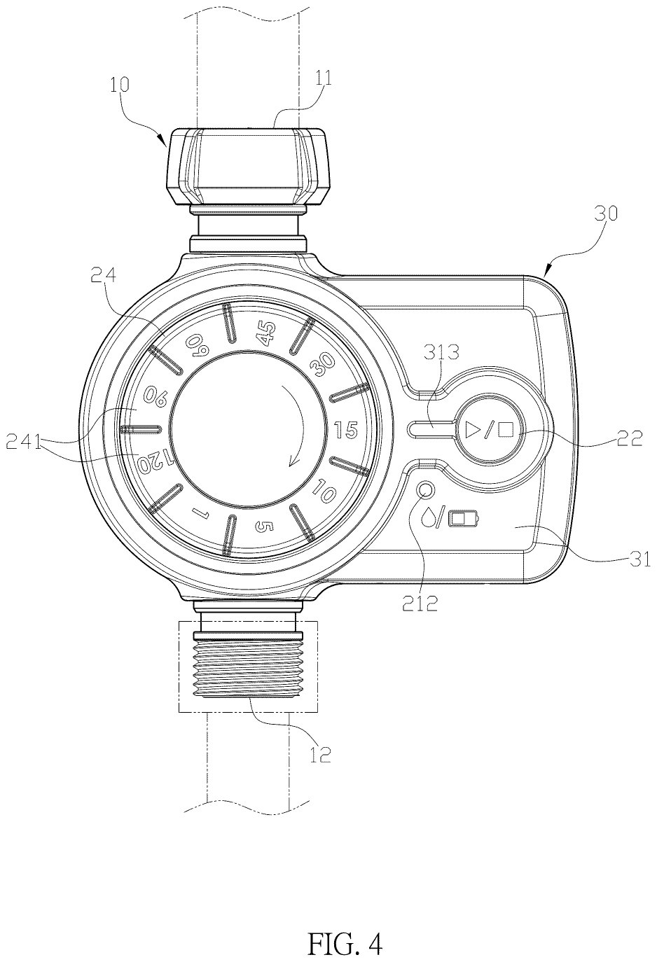

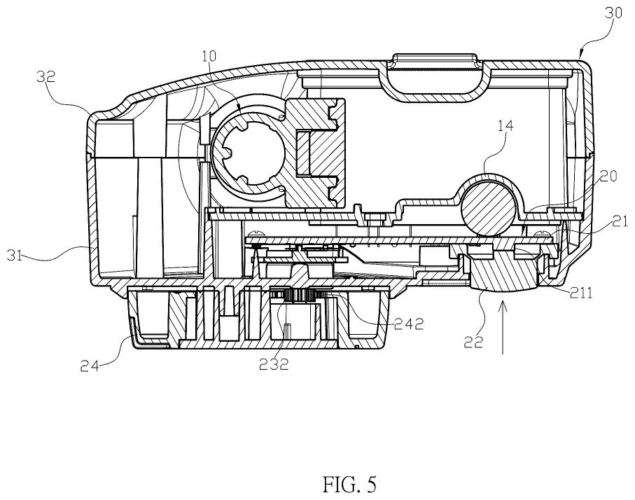

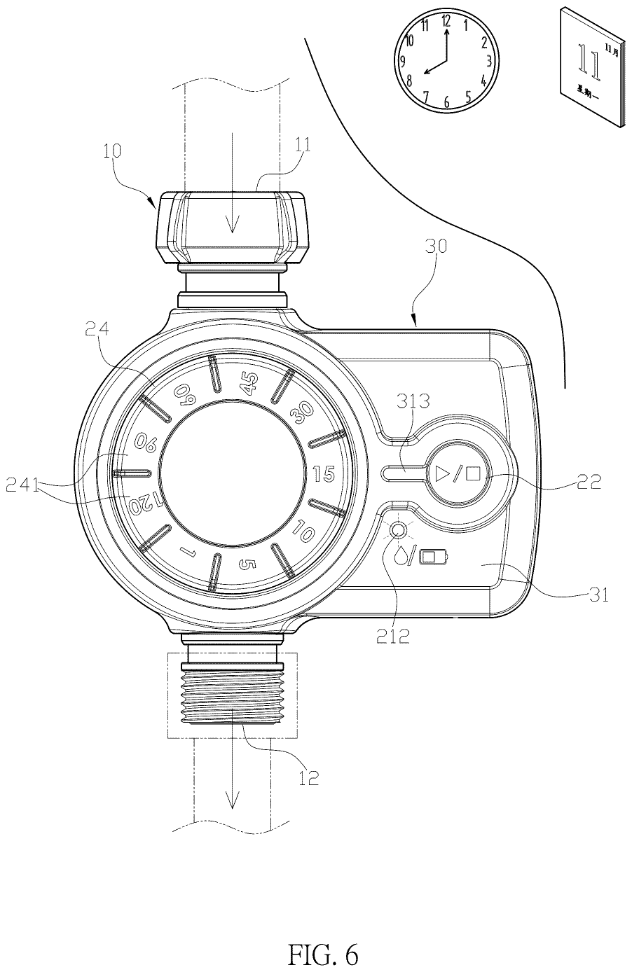

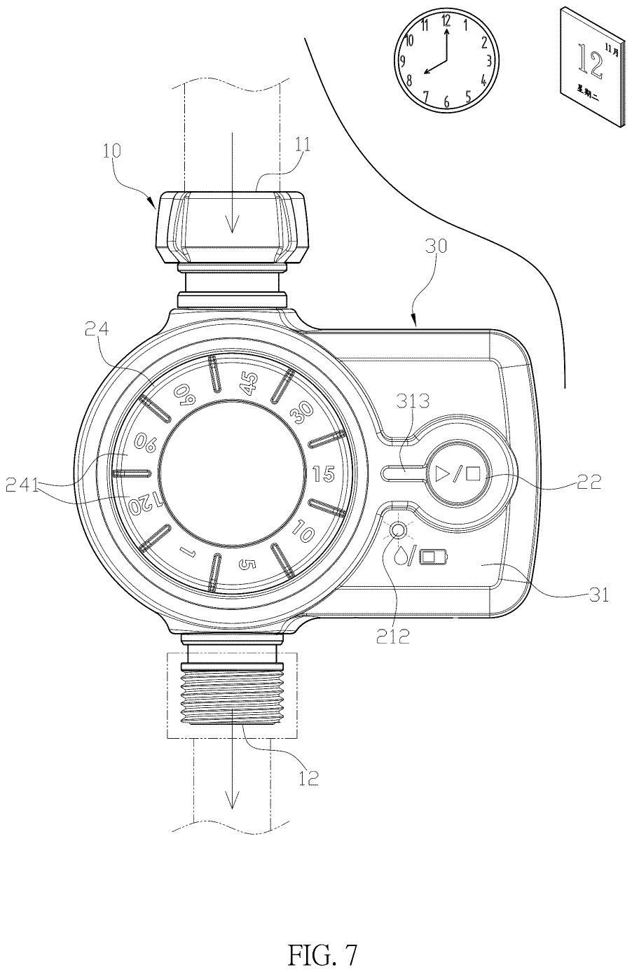

Given the aforesaid technical features, both the inlet portion (11) and the outlet portion (12) enable the gardening flow control timer of the disclosure to be mounted on a gardening water supply system, such as an automatic sprinkler irrigation system, and adapted to allow a water flow to pass through the valve body (13) and be switched by the timer circuit (20) such that the water flow can flow through the gardening water supply system efficiently or be blocked by the valve body (13). Upon completion of the installation, the rotation (as shown in FIG. 4) of the turntable (24) is the only requirement for adjusting the duration of continuous water discharge. Then, the single toggle switch (22) is pressed (as shown in FIG. 5) such that daily scheduled water discharge can be set. Upon completion of the setting process, the gardening flow control timer of the disclosure can use the timer circuit (20) to take the initiative to cause the valve body (13) to open and close (as shown in FIG. 6 and FIG. 7) at the same time every day thereafter. Therefore, the disclosure is effective in simplifying the setting process greatly, stopping the water supply by pressing the single toggle switch (22) again as soon as water supply is no longer necessary, for example, if it rains during the set time period, and performing the setting process by aligning a corresponding one of the time markings (241) with the pointer (313) while the turntable (24) is rotating.

The aforesaid technical features of the aforesaid specific embodiments have advantages as follows: (1) rotating the turntable (24) and pressing the single toggle switch (22) once together make setting the timer circuit (20) intuitive and simple, and the structure that eliminates the need to press a lot of buttons but is still able to set water discharge time is easy to use; (2) the timer circuit (20) only needs to complete the initial rotation, and after pressing, it can achieve a normal water discharge at the same time every day, and the operation is so simple that the gardening flow control timer of the disclosure is suitable for all age groups.

Therefore, the present invention not only embodies radical innovation and improvements on prior art but also exhibits high industrial applicability, inventiveness, and novelty.

The disclosure is disclosed above by a preferred embodiment, but the preferred embodiment is not restrictive of the scope of implementation of the disclosure. All equivalent changes and modifications made to the preferred embodiment according to the claims of the disclosure shall be deemed falling within the scope of the claims of the disclosure.

What is claimed is:

1. A gardening flow control timer, comprising:
a flow controller having an inlet portion and an outlet portion, with a valve body located between the inlet portion and the outlet portion, disposed on a lateral side of the flow controller, and electrically connected to the timer circuit in order to be controlled by the timer circuit to allow waterway inside the flow controller to open or close according to opening and closing variations resulting from operation of the valve body;
a timer circuit having a substrate, the substrate containing a control program and having a start button and a single toggle switch connected to the start button, the single toggle switch being pressed to cause the start button to trigger the timer circuit and cause the substrate to record a time of a first trigger to not only allow the substrate to take initiative to start the timer circuit at a same time every day thereafter, but also allow the single toggle switch to be pressed once again during a starting process of the timer circuit to perform a function of one-time shutdown, the substrate having a timing unit, the timing unit having a rotating shaft extending therefrom and connecting to a turntable, the turntable having a plurality of time markings equidistantly spaced such that each of the time markings denotes a unique countdown time; and
an outer casing formed by aligning and combining a first casing body and a second casing body, with a plurality of notches disposed at edges of the first casing body and the second casing body, the first casing body having a through-hole and at least one perforation, wherein the first casing body and the second casing body are aligned and combined to allow the flow controller and the timer circuit to be further received in the outer casing, allowing the inlet portion and the outlet portion to be protruded from the notches, wherein the through-hole has a clearance function, allowing the turntable disposed outside the first casing body to connect with the timer circuit disposed in the outer casing, and allowing the single toggle switch to be exposed from the perforation, wherein a pointer is disposed on an outer surface of the first casing body, wherein a battery case capable of being pulled outward is disposed in the second casing body and contains a battery for providing electric power to the timer circuit and the valve body in operation.

2. The gardening flow control timer of claim 1, wherein the valve body is an electromagnetic valve.

3. The gardening flow control timer of claim 1, wherein the flow controller has a baffle which the timer circuit abuts against whenever the timer circuit and the flow controller are placed in the outer casing and fastened in place.

4. The gardening flow control timer of claim 1, wherein the substrate is a circuit board having a program chip.

5. The gardening flow control timer of claim 1, wherein the substrate has thereon an indicator light exposed from the perforation and adapted to turn on to prompt a user to replace the battery when the battery is about to run out, and the program contained in the substrate controllably causes the indicator light to light up as soon as the timer circuit starts and thereby allows a water flow to pass.

6. The gardening flow control timer of claim 1, wherein the rotating shaft is connected to a gear, and the turntable has an internal gear portion meshing with the gear to allow the turntable and the rotating shaft to transmit power more precisely.

7. The gardening flow control timer of claim 1, wherein the turntable has the time markings denoting one-minute, 5-minute, 10-minute, 15-minute, 30-minute, 45-minute, 60-minute, 90-minute, and 120-minute countdowns respectively.

8. The gardening flow control timer of claim 1, wherein each of the time markings of the turntable corresponds in position to a positioning hole, and the first casing body has a positioning pin capable of being pushed outward by a spring and inserted into a corresponding one of the positioning holes while switching between the time markings occurs as a result of rotation of the turntable to not only achieve accurate positioning for switching but also generate a sharp gear-shifting feel.
